(19) United States
(12) Patent Application Publication
(10) Pub. No.: US 2008/0015995 A1
(43) Pub. Date: Jan. 17, 2008

(54) Standalone content protection storage device

(76) Inventor: Yeacheiung Eric Chen, Edison, NJ (US)

Correspondence Address: Yeacheiung Eric Chen, 24 Bodnarik, Edison, NJ, 08837, US

(21) Appl. No.: 11/487,807

(22) Filed: Jul. 17, 2006

(51) Int. Cl. G06Q 99/00

(52) U.S. Cl. 705/50

(57) ABSTRACT

This invention is an independent device provides content protection for an individual storage media such as a hard disk with information based identity such as a pass code or biometric information as identity information for accessing blocking and content encryption to prevent the exposure of the content on the protected media under unauthorized use of the media. The encryption key used in the encryption process is created on the flight and will be removed after each use. The invention binds the authentication and the encryption in series; the encryption key is only created under the successful authentication process. The invention is self equipped with authentication, authorization, and encryption and it is independent from a host's platform or operating system. Two embodiments are described in this disclosure. One centers on biometric such as fingerprint. The other centers on a pass code approach. Any computer with connector such as RJ45, USB2.0, IEEE1394, SCSI, or eSATA can employ this invention internally or externally. RJ45 is for network connectivity with public protocols such as FTP (File Transfer Protocol) or NFS (Network File System).

### CROSS-REFERENCE TO RELATED APPLICATIONS

This application claims the benefits of PPA 601/701,529. filed on Jul. 18, 2005 by the present inventor. A product named as ContentSafe by Transcom/AVI inc., owned by and being operated by the present inventor, has incorporated the numerical embodiment of the PPA aforementioned.

### FEDERALLY SPONSORED RESEARCH

Not Applicable

### SEQUENCE LISTING OR PROGRAM

Not Applicable

### BACKGROUND OF THE INVENTION

1. Fields of the Invention

This invention concerns the data safety of a storage media that is external to a computer.

2. Prior Art

Protection on content done by a computer has been around for a while, even some form of specialized storage systems are available in the market. These implementations mainly comprise of on the authentication, authorization processes, and data encryption. A specialized storage system is done with a specialized and full fledged computer typically; and basically it handles storage requests with special protocols. And these types of systems tend to be pricy and not really portable to fit a present trend. It is a common practice now just to carry the individual storage media such as a hard disk to transport the digital information for self use in other places or to others for sharing.

Recently, there are storage protections for individual storage media in the market. There are several schemes in these areas. One of them depends on the host to do everything from access authorization, access blocking, to content encryption. This scheme is too much dependent of a host. If a host is upgraded, the scheme can well cease to work. Some depends on the host to only perform access blocking without encryption; it is not tempering proof. Some scheme includes a mechanism to lessen the dependency to a host by storing host programs for security on the storage media itself. It can be used on other host of the same intended generic. These programs would be loaded to a host so that control over the storage media can be activated. Either way, these schemes only works when the connected host is of special generic with a specific operating system. And the host has to be working so that the schemes mentioned can work.

There are cases where a hard disk itself is equipped with a locking mechanism to prevent unauthorized access. However, this implementation requires a host to operate as well. Because disk plates in a hard disk can be separated from the disk housing, therefore a disk with a lock is not tempering proof. This scheme provides a very limited access blocking.

There is a host independent secured data storage device in the market today, which utilizes a token key. The token key basically is a piece of memory holding the encryption key used in the content encryption process. The encryption process is a process requires an encryption key that cryptographs the content. It transforms the content into something that cannot be recognized without the reverse process—decryption. A token key can be lost, replicated, or compromised because the content of the key can be dumped. All of these possibilities expose the protected content to inaccessibility or to unauthorized usage.

### OBJECTS AND ADVANTAGES

The invention is an affordable content storage device that can offer the protection of the content on the individual storage media level and be independent of the host. With the use of a computer becomes less of a barrier, the information stored in a computer will not be safe from accidental access or intentional but unauthorized access. The digital information eventually is stored in a content storage device that is used by a rendering device or a computer that can display, print, play, fetch, and store the digital information. These information or content storage such as a hard disk has, in recent years, turned into a favorable mobile device. With the capacity of a hard disk increasing, more information is placed on a single storage media. Some of them bound to be sensitive for business and embarrassing for individuals if exposed unnecessarily. It has been recognized that the protection of the content on these storage devices is of extreme importance in business world, in government establishment, or simply for personal privacy. Traditionally, due to complexity and the cost, it is very prohibitive to have such protection universally applied on individual storage media. And it is even harder to be both affordable and secure at the same time. It is also a very tough to be bale to move freely among different computers or operating systems. The invention will accomplish all of these points mentioned.

Some protection of the digital information is tied to a rendering device or a host such as a computer. Such protection has one drawback in that when the rendering device has failed, the rightful owner of the protected content would have hard time to recover data without elaborated effort. Therefore it is desirable that there should be a protection of the data storage that is totally independent of the rendering device or the host. Also because the fact that the rendering device has been updated rapidly, it is very desirable that the content is in a storage with the protection that can be migrated to new rendering device without installing new software on the host.

Accordingly, besides the present invention has an advantage of not having to carry a physical key of some form, several objects and advantages are:

a). The invention has authentication, authorization, encryption capabilities all by itself.
b). It can be used on any computer platform and operating system.
c). It is tempering proof.
d). It is mobile.
Additional advantages are the following:

It can be used to boot a system because it performs the entire authentication, and the decryption on the device itself. Once a user passed the security checks, the system image on the invention can be used as an image of the operating system; so long as a host system can be booted from the connector the invention uses, a host can be booted from the invention.

The format information on the protected storage media is encrypted. Once tempering attempts separate the protected storage media from the invention and use in any other manners, the storage media will come across only as a unformatted media and will further reduce the temptation of hacking.

It is affordable. The two alternatives described in the present invention can be implemented with hardware that cost less than half of a Broadway show present ticket price. In a fingerprint version, an Authentech chip for fingerprint sensor is under USD$10. An ADI DSP to perform minutiae analysis is under USD $5.00, 2M flash for firmware is USD $1.00, 64 M bytes ram are less the USD$2.00, an xWall cryptograph engine chip of DES 64 bits is about USD$10. These are the main components needed for the embodiment discussed. In a pass code version, additional saving on fingerprint sensor, DSP, and memory can also be achieved by replacing aforementioned by a 8051 type of chip for USD1.00.

Further objects and advantages of my invention will become apparent from considerations of the drawings and ensuing descriptions.

### SUMMARY

This invention delivers content storage capacity while provides the content protection from unauthorized accesses against the content on line or off-line. On line access blocking is done by not allowing the host connection to a host in unauthorized manners. Off line protection is done with data encryption. The encryption key used is disposable; the same encryption key is only created when authentication is passed by a user. The encryption key is removed as soon as it is consumed by the cryptograph engine in the invention. The invention uses an ID reader which receives either biometric information or pass codes for identity information. There will be no needs for any physical means to pass the access blocking in order to activate the invention and to be successfully used by an authorized user. Via different encryption keys for different instance of the invention, the storage media is bound to a particular instance of the invention.

The invention has a common content storage media such as a hard disk that can facilitate a content placement scheme with high performance in speed and time saving. The invention has a cryptograph processor that binds the media such as a hard disk to the invention so that the content in the content storage can only be accessible through the invention. Because the storage media is common and be acquired easily, the invention can be used to protect more than one content storage media. The device will behave differently based on the authorization of a user. For an owner, the individual can authorize additional users or release the ownership to others. For a non-owner user, only the storage access can be done and nothing else.

The invention performs all the authentication, authorization, and encryption on the device itself, hence it is host independent and there is no need for the key management.

### DRAWINGS—FIGURES

FIG. 1 Shows preferred embodiment, biometric, functional blocks

FIG. 2 Shows fingerprint record

FIG. 3 Shows operation mode control panel

FIG. 4 Shows operation mode LED Indicators

FIG. 5 Shows status LED Indicators

FIG. 6 Shows algorithm for the preferred embodiment

FIG. 7 Shows alternate embodiment, pass code, functional blocks

FIG. 8 Shows pass code record

FIG. 9 Shows operation mode control panel

FIG. 10 Shows Operation Mode LED Indicators

FIG. 11 Shows status LED indicators

FIG. 12 Shows numerical key pad

FIG. 13 Shows connectivity controller

FIG. 14 Shows algorithm for the alternate embodiment

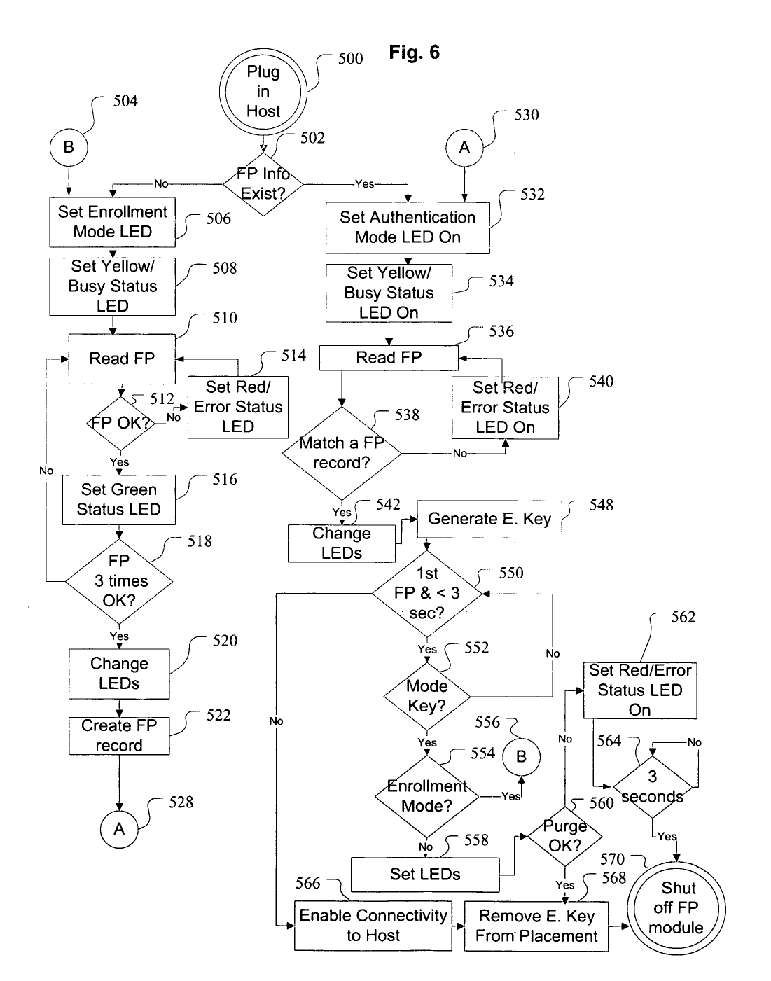

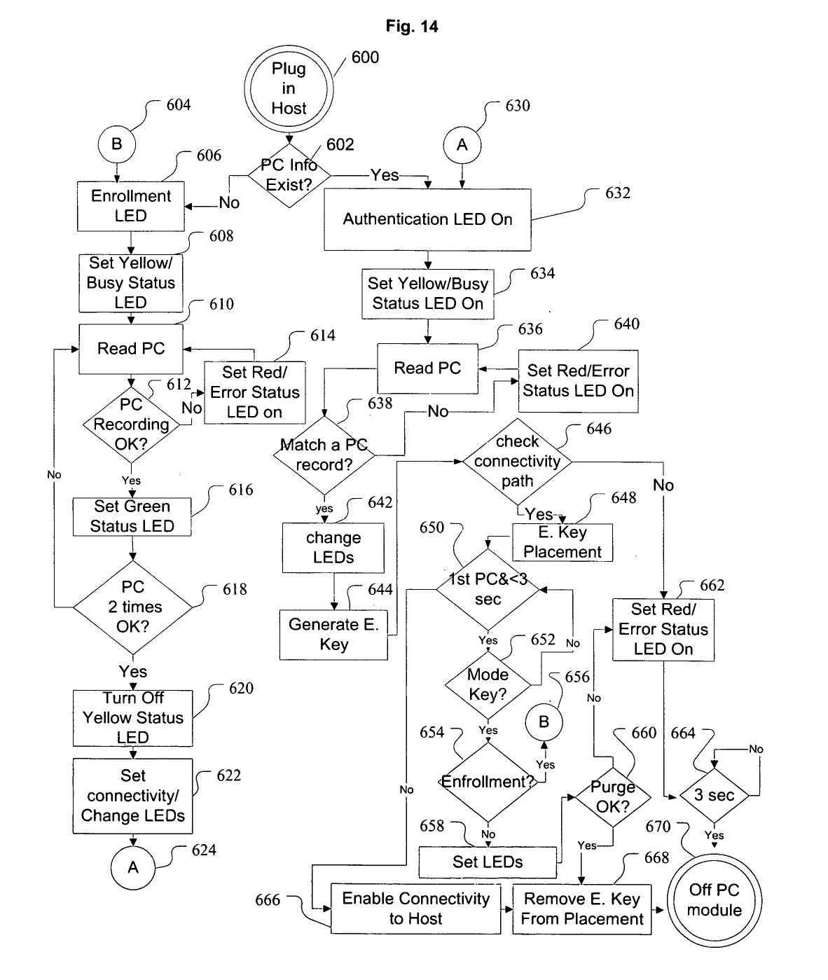

DRAWINGS - Reference Numerals

| | | | |
|---|---|---|---|
| 10 | Unser Interface | 12 | Fingerprint Sensor |
| 14 | Operation Mode Control keys | 16 | Operation Mode Indicators |
| 18 | Status Indicators | 20 | Biometric(fingerprint)Based Identity Process |
| 22 | Power Unit | 24 | Encryption key Buffer |
| 30 | Cryptograph Engine | 34 | Connector |
| 36 | Content Storage Media | 48 | Miniutiae records |
| 49 | Encryption key root | 50 | FP Reader |
| 52 | FP Verifier | 54 | FP Handler |
| 56 | FP/E Key Root Storage | 72 | Purge Key |
| 74 | Reset Key | 76 | Enrollment Key |
| 78 | Purge Mode Indicator | 80 | Authentication Mode Indicator |
| 82 | Enrollment Mode Indicator | 83 | Power Indicator |
| 84 | Busy Indicator | 86 | Error Indicator |
| 88 | OK Indicator | 110 | Alernate Embodiment User Interface |
| 112 | Numerical Keypad | 114 | Operation Mode Control keys |
| 116 | Operation Mode Indicators | 118 | Status Indicators |
| 120 | Pass Code Identity Processor | 122 | Power Unit |
| 124 | Encryption key Buffer | 128 | Network Connector |
| 130 | Crptograph Engine | 132 | Peripherial Port Connector |
| 134 | Storage Media Connector | 136 | Storage Media |
| 138 | Pass code records | 139 | Encryption key root |
| 150 | Pass Code Reader | 152 | PC Verifier |
| 154 | PC handler | 156 | PC/Encryption key root storage |
| 172 | Purge Key | 174 | Reset Key |
| 176 | Enrollment Key | 178 | Purge Mode Indicator |
| 180 | Authentication Mode Indicator | 182 | Enrollment Mode Indicator |
| 184 | Busy Indicator | 186 | Error Indicator |
| 188 | OK Indicator | 190 | Power Indicator |
| 192 | Connectstivity Indicator | | |
| 500 | Steps and decisions of flow | 600 | Steps and decisions of |
| to | chart in FIG. 6 | to | flow chart in FIG. 14 |
| 570 | | 670 | |

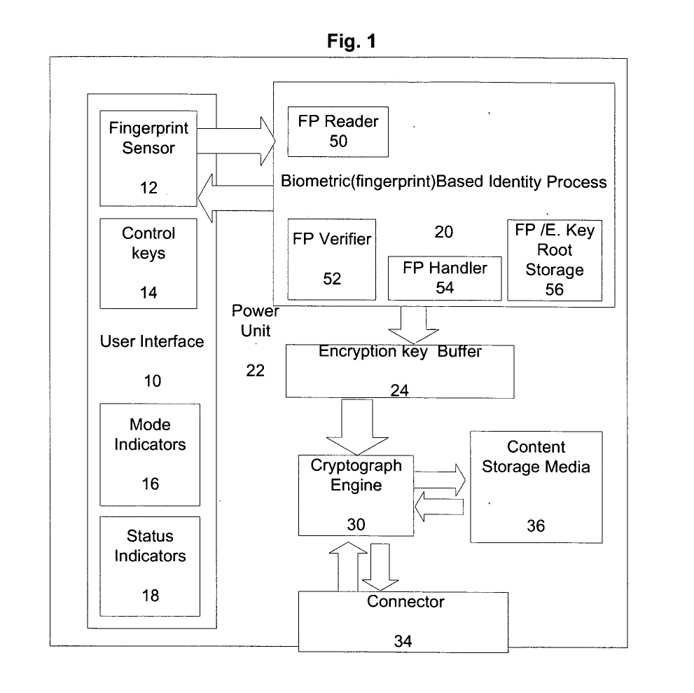

### DETAILED DESCRIPTION—FIG. 1,2,3,4,5,

### The Preferred Embodiment

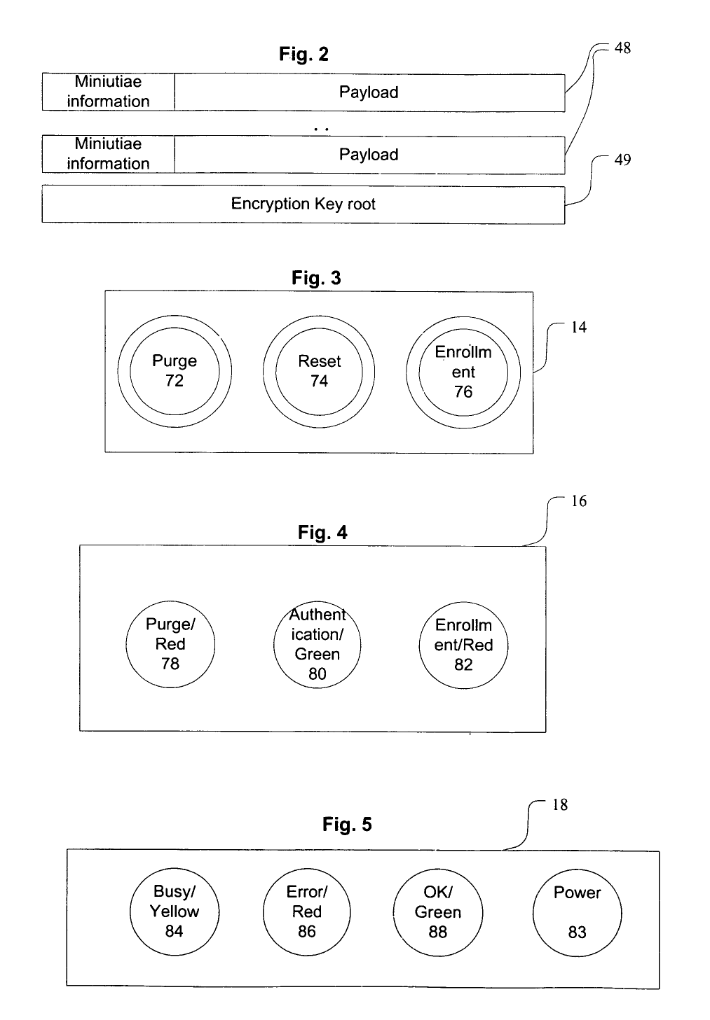

A preferred embodiment of the invention is depicted in FIG. 1. The device has three major modules namely a user interface 10, a biometric identity processor 20, and a cryptograph processor 30. Additional modules are: a content storage 36, an encryption key buffer 24, a power unit 22, and a connector 34. The encryption key buffer 24 holds the encryption key created from the encryption key root 49 in FIG. 2. The encryption key is held just long enough to be imported by the processor 30. The encryption key placed in the buffer 24 is only generated when a user is authorized to access the embodiment. Fingerprint (FP) is used as the identity information in authentication process to check if a user is authorized. The power unit 22 provides the necessary power to the modules described above that can be connected or disconnected under the control of the identity processor 20. The embodiment has a connector 34 for connecting the embodiment to a host.

The user interface 10 has a number of components namely the FP sensor 12, a control key pad 14, mode LED indicators 16, and the status LED indicator 18. The FP sensor 12 is always set to pick up fingerprint in an optimum resolution. The operation mode control keypad 14 in FIG. 1 is detailed in FIG. 3, has buttons for mode selections: Purge button 72 to clear all the FP records 48 in the FP storage 56 to prepare for accepting a new owner, the reset button 74 to restart an on-going operation, and the enrollment button 76 to enroll the owner FP information or to add a new user's FP. The mode LEDs 16 of FIG. 1 is detailed in FIG. 4 to reflect the mode the invention is in. The green LED 80 is lit when the mode is in the authentication mode, the normal operation mode, and ready for FP reading. The purge red LED 78 implies that the system is in the purge mode. The red enrollment red LED 82 implies that the enrollment mode is assumed or selected. The status LEDs 18 in FIG. 1 is depicted in the in FIG. 5 where a green power indicator 83 implies a host is successfully connected. A yellow LED 84 signifies that the invention is busy and would not accept any input or control. A red LED 86 indicates that the operation just performed is in error. A green LED 88 represents that the operation just performed is successful. The LEDs can be replaced by an LED displays if cost is not an issue.

The identity processor 20 verifies that a user is indeed an authorized user of the embodiment. This embodiment uses the biometric information such as FP to positively identify a user. The identify processor 20 comprises of a number of sub-modules namely a FP reader 50, a FP verifier 52, a FP handler 54, and a FP storage 56. The FP reader 50 takes the image from the FP sensor 12 on the user interface module 10 and performs minutiae analysis to produce minutiae as the representation of the fingerprint just read. If the invention is in the enrollment mode, the fingerprint information eventually gets stored in the storage 56. It is either in the form of minutiae or in other forms that has high correlation to individual fingerprint minutiae.

The storage 56 is used to store FP records 48 and an information record 49 for encryption key root. Each instance of the embodiment would have a different value in encryption key root 49. The encryption key root 49 is used to generate encryption key to be used in content cryptograph processor 30. Each instance of the embodiment has a distinctive encryption key root. Under the normal operation mode, the FP verifier 52 checks the FP information of a user against the FP records 48 in the FP storage 56. The result is reflected on the status LEDs 68 n FIG. 5. A valid user's fingerprint information in the form predetermined as records 48 is, via the FP handler 54, written to the storage 56. An FP record 48 contains minutia data, and payload. The payload field in an FP record 48, FIG. 2 is for information that can be coupled for authentication purposes in the future.

The cryptograph processor 30 scrambles data as in a typical cryptograph process before data is placed in the content storage 36. It un-scrambles data when data is fetched from the content storage 36 by a host. It takes the encryption key from buffer 24 after the key is created by processor 20 from a unique encryption key root 49. These mechanisms force the content storage module 36 to be bound with a particular instance of the embodiment. Consequently, the protected storage media can only be accessed successfully via the very instance of the embodiment that is used to format the storage media originally. The encryption key aforementioned is DES (data encryption standard) 64 bits encryption key stored in the buffer 24. The existing art for a single chip cryptograph engine 30 can take triple DES with little or no performance concerns. Existing arts can also support AES (Advanced Encryption Standard) 128 bits easily. The longer the encryption key the better the protection against tempering effort.

The content storage module 36 provides the memory space for the content to be stored. It is a typical mass storage device such as a hard disk commonly seen in a personal computer or a notebook computer. The disk has a connector to be connected to a host internally and it is duplicated for internal use—in this case the connector 34 is the replicated connector on the media. Or connector 34 converts the media connector to an external one such as USB2.0, IEEE1394, eSATA, or SCSI. These external connectors are widely supported among hosts of many generics. The content storage 36 may be separated by a user from the embodiment because it can be full and a new storage would be needed. A host formats the disk space to create a file system that is based on a user's choice. File systems are mostly operating system independent today. The format information is written when the disk is initialized after a user has passed through the authentication. Authentication process will be detailed in the operation section later. If the disk is used in another instance of the embodiment, the disk will appear to be not formatted.

### Operations—FIG. 6

The invention is used as an external hard disk drive mostly. The content access aspects are identical to a typical hard disk drive in an external adaptor when user authentication has passed. Additionally the content encryption is done on the flight and it is transparent to a user. The descriptions of this section concern how to bind a hard disk to the invention, how an owner is established, how a user is authenticated, and how a user is authorized. Individual processes for the establishment of the blocking, enrolling additional users, and ownership transfer will also be detailed.

A hard disk has to go through the binding process in the invention in order to protect the content to be stored on the disk later. Valid users are authorized through the enrollment process. And the authentication process can validate a user's ID by checking if a FP placed on the sensor 12 matches one of those stored in the FP storage 56 in FIG. 1. The transfer of the ownership relies on the ability to purge the ID information but retains the encryption key that is generated each time the authentication is successfully done. These different operation scenarios are detailed below.

### Binding Operation

The binding process ensures the physical items that can be separated from the body of the invention are used together always. The binding between the storage media 36 and the invention happens when the storage 36 is placed in the invention and through the initialization by a host after user authentication has passed. Successful user authentication creates the encryption key that is needed in the binding process.

The newly added storage 36 comes across as a new hard disk drive to a host. The host would have to go though disk initialization process to format the disk for future access. Disk format information goes through the cryptography engine 30, hence only the invention presents the storage in question to the host as a disk ready for access. Otherwise, the hard disk will appear to be a new drive that needs initialization. The binding between the storage 36 and the invention happens once per disk unless the disk is to be reformatted and reused. Except for the action that a user has been authenticated as an authorized user, the binding process is actually the disk formatting process of a new disk by a host.

The embodiment uses the unique encryption key root stored in the record 49 of FP storage 56 to generate a disposable encryption key for cryptograph engine 30. To a host, any data has to go through the cryptograph engine 30 into or out of the storage 36. The format information of the storage is no exception. This approach discourages reverse engineering by malice users; because a person tends to ignore a blank disk, the format type and content in the file system will avoid being put through rigorous hacking. If the disk has been used in raw mode, it would also be very difficult for a hacker to detect that the disk actually has been used in raw mode.

The encryption key used in the binding process can not be read by dumping any memory in the embodiment so it is tempering proof in a very extremely sense. Apparently this feature provides superior tempering proof by binding the media to the embodiment and the encryption key to the authentication process.

### Enrollment Process

In FIG. 6, step 504 to the step 528 deal with the initialization operation process when a new embodiment is involved, additional user is authorized, or a new owner has assumed the device. With a brand new embodiment of the invention, there will be no FP record in the FP storage 56. Decision 502 checks that. A new embodiment and a new owner are two scenarios where there will be no FP records 48 in the storage 56. When there is no FP record, the device assumes the enrollment mode and sets the enrollment LED 82 in step 506 automatically. The busy yellow LED 84 is lit in step 508 to anticipate a long process of enrollment. The enrollment process is also invoked via the B label pairs 556, 504 by the step 554 when a user presses the enrollment button 76. A user can do that only after the individual has passed as an owner in the authentication process from step 532 to step 542. This will be detailed in the authentication process described below. The user passes one finger of choice over the fingerprint sensor 12 in step 510. The system confirms that the quality of the input is adequate in step 512. The OK LED 88 is lit in step 516 when FP quality is acceptable otherwise an error LED 86 is lit in step 514 to ask a user to perform step 510 again, putting the same finger on sensor 12. To create better minutia information, the user is asked, by decision 518, to do these several times until there are 3 FPs of good quality for minutiae generation. When everything is checked out, the step 520 set LEDs: an OK LED 88 in FIG. 5 is lit, the enrollment mode LED 82 is turned off, and the busy status LED 84 is tuned off. Meanwhile a FP record 48 is created for this new FP in step 522. Step 528, leads to label A 530 to perform the authentication process.

### Authentication Process

When the embodiment is first connected to a host, the busy indicator 84 in FIG. 5 will flash to signal that the device is getting ready and a green authentication mode LED 80 is eventually lit when the device is ready to read the ID information. A user places a finger on the fingerprint sensor 12 which will allow the fingerprint reader 50 to pick up the image of the fingerprint. The fingerprint image is then put through the minutiae analysis algorithm which may involve normalization process for identity verification purposes. The result of the analysis is then used to match with the data in the identity information storage 56. If a match is found, the authentication is considered passed and the OK indicator 88 is lit. When authentication is successful, the encryption key to be read by the cryptograph engine 30 right away is created from the encryption key root 49 of the storage 56. At the end of the authentication process the disposable encryption key is removed from the buffer 24.

In the flow chart depicted in FIG. 6, the step 530 to the step 570 deal with the authentication process mainly. After the invention is put to use, there will be at least one FP record 48 in the FP storage 56. Decision 502 checks that. When there is any FP irecord, the device assumes the authentication mode automatically; step 532 turns on the authentication LED 80. Meanwhile the busy LED 84 is set on step 534 to wait for the user to put finger on sensor 12. The step 536 reads the FP when a finger is chosen by the user and placed on the FP sensor 12. Decision 538 checks if the finger matches any FP record 48 in the FP storage 56. If there is no matched FP record, an error indicator 86 is set on. Meanwhile it waits for a finger to be placed on the sensor 12 in step 540 until a right finger is used. Step 542, following an FP match in decision 538, makes changes to the LEDs: off for error LED 86, on for OK LED 88, and off for busy LED 84. The recorder number of the matched FP record is remembered in step 542. Step 548 generates the encryption key from the encryption key root 49 in the FP storage 56.

Decision 550 proceeds to complete the connection to a host in step 566 when the user is not an own or there is no mode change within 3 seconds. And step 568 will remove the encryption key from the buffer 24. Step 570 terminates the whole process by disable the identity process 20.

When a user's FP matches 1st FP record in the storage 56, there is a 3 second timer involved in decision 550 to see if, within 3 seconds, there is an operational mode change. Decision 552 checks if either the purge action 72 is pressed or the enrollment action 76 is pressed by a user. If the enrollment key 76 is pressed which is checked in decision 554, then the process would follow the flow chart B label pair 556, 504 to perform the enrollment. The enrollment process, step 506 to step 526, has been detailed previously. Otherwise, step 558, following decision 554, has assumed the purge mode key 72 is pressed when one of the operation mode keys is pressed and it is neither the enrollment key nor the reset key 74—reset key will force processing to go back to 502. The purge process is detailed right after the authorization process below.

### Authorization Process

Authorization can only be performed when the user is an owner and the enrollment key 76 is pressed within a predetermined duration, i.e. 3 seconds. The process is completed after a new FP record 48 is added to the embodiment's storage 56.

When the user's FP matches 1st FP record in the storage 56, there is a 3 second timer involved in step 550 to see if, within 3 seconds, a check in decision 552 is made to see if change of operation mode is signaled. Decision 554 checks if the enrollment key 76 is pressed to proceed to follow the flow chart B label pair 556, 504 to perform the step 506 to step 526 which has been detailed in the enrollment process described above.

### Purge Process

In the business world, it is quite common that the content has to be transferred from one individual to another due to promotion, job transfer, or resignation. In this circumstance, it is crucial to allow the device to be able to erase all the ID information to accept the IDs for the new owners. A user has to go through the authentication process before the purge action can be activated. In FIG. 6, the purge mode is invoked after decision 550 to step 558. In FIG. 6, the purge mode includes step 558 to step 570. Before the purge mode is invoked, the authentication process has to be passed as described above. Step 558 changes LEDs to inform a user: the authentication mode LED 80 is turned off, the purge mode LED 78 in FIG. 4 is turned on, the status OK LED 88 is turned off, and the busy status LED 84 is turned on. The invention monitors the progress by decision 560 for FP information erasing. The OK LED 88 is turned on as soon as the purging task is completed. If the purge failed, the error indicator 82 is turned on in step 562. When the purge process is completed successfully, the status OK LED 88 in FIG. 5 is turned on, the purge mode LED 78 is turned off, and the yellow busy status LED 84 is turned off. Step 568 removes the encryption key from the buffer 24,

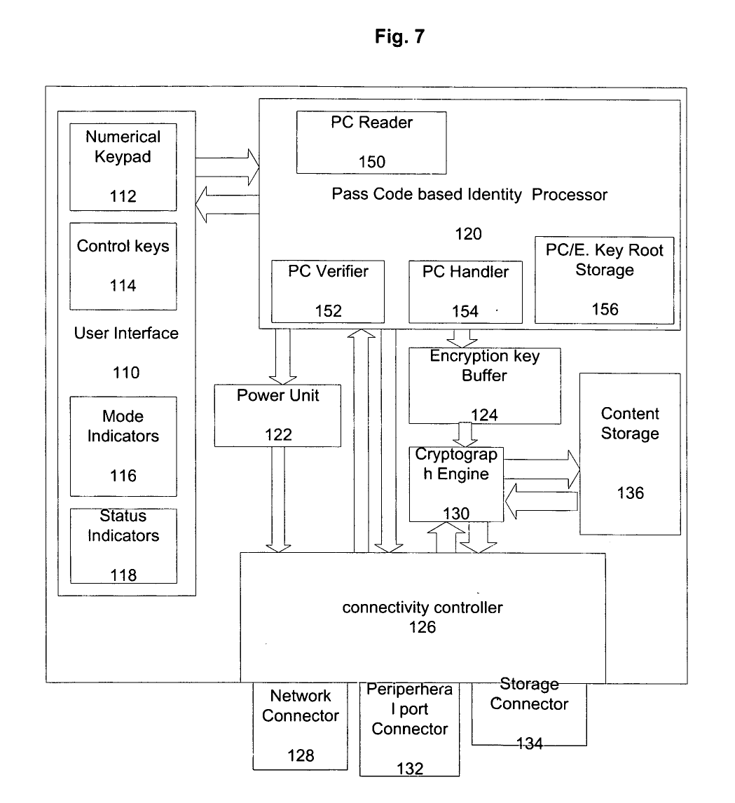

### DETAILED DESCRIPTION—FIG. 7,8,9,10,11,12,13

### Alternate Embodiment

An alternate embodiment of the invention is depicted in FIG. 1. The device has three major modules namely the user interface 110, identity processor 120, and the cryptograph processor 130. These additional modules are: a content storage 136, an encryption key buffer 124, power unit 122, connection control 126, and connectors 128, 132, 134. The encryption key buffer 124 holds the encryption key just long enough to be imported by the cryptograph processor 130. The encryption key placed in the buffer 124 is generated from a root that is embedded. A pass code (PC) is used as the identity information in this embodiment. The power unit 122 provides the necessary power to the modules described above that can be connected or disconnected under the control of the identity processor 120. The embodiment has multiple connections to a host. There is a network connector 128 next to a USB 2.0 connector 132 and a connector 134 of the storage media itself.

The interface 110 has a number of components namely the numerical keypad 112, control key pad 114, mode LED indicators 116, and the status LED indicator 118. The keypad 114 in FIG. 7 is detailed in in FIG. 9, has buttons for mode selections: Purge button 172 clears the PC storage 156 to prepare for accepting a new owner and new users. Reset button 174 restarts a on going operation. Enrollment button 176 starts to enroll the owner PC information or to add a new user.

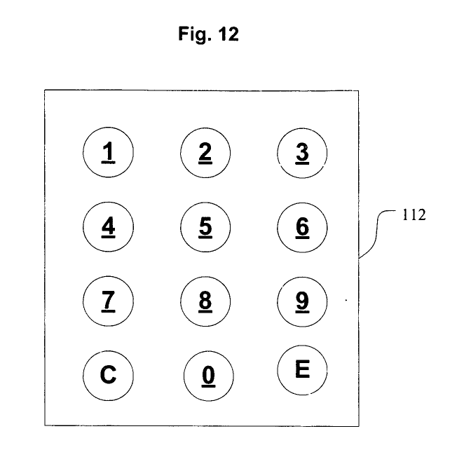

The mode LEDs 116 is detailed in FIG. 10 to reflect the mode the invention is in. The green LED 180 is lit when the mode is in the authentication mode, the normal operation mode, and ready for PC reading. The purge red LED 178 implies that the system is in the purge mode. The enrollment red LED 182 implies that the enrollment mode is selected. The status LEDs 118 is depicted FIG. 11. The yellow LED 184 signifies that the invention is busy and would not accept any input or control. The Red LED 186 indicates that the operation just performed is in error. The Green LED 188 represents that the operation just performed is successful. Green power indicator 190 shows the power is on. Red connector indicator 192 shows the connection to a host is completed. The LEDs can be replaced by an LCD displays if cost is not an issue. Numerical keypad 112 detailed of FIG. 12 has 0 to 9 numerical keys, cancel key C, and Enter key E.

ID processor 120 is an embedded processor and it uses PC entered by a user as the identity information. This module generates encryption key from an encryption key root 139 that is embedded in storage 156. It places the generated key in the encryption key buffer 124. It has the corresponding sub-modules as the followings: PC reader 150 reads PC entered by a user. PC verifier 152 validates if PC matches one of the PC records. PC handler 154 reads/writes PC records 138 in PC storage 156.

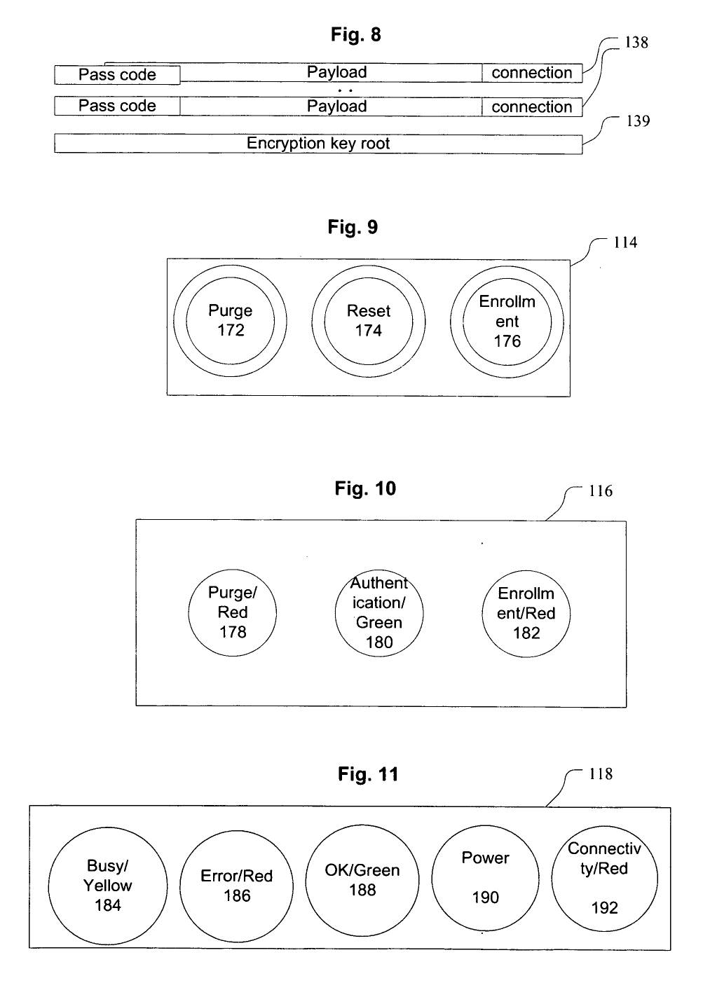

PC storage 156 depicted in FIG. 8 holds data such as encryption key root 139 and PC records 138 depicted. A PC record 138 has the following fields: PC, payload, and connectivity path field. Value 1 in this connectivity path field means the user just enrolled can only use the network attachment such as wireless USB or Ethernet. Value 2 means the second type of connectivity, as a peripheral attachment such as USB2. Value 3 can only use the internal connectivity to a host.

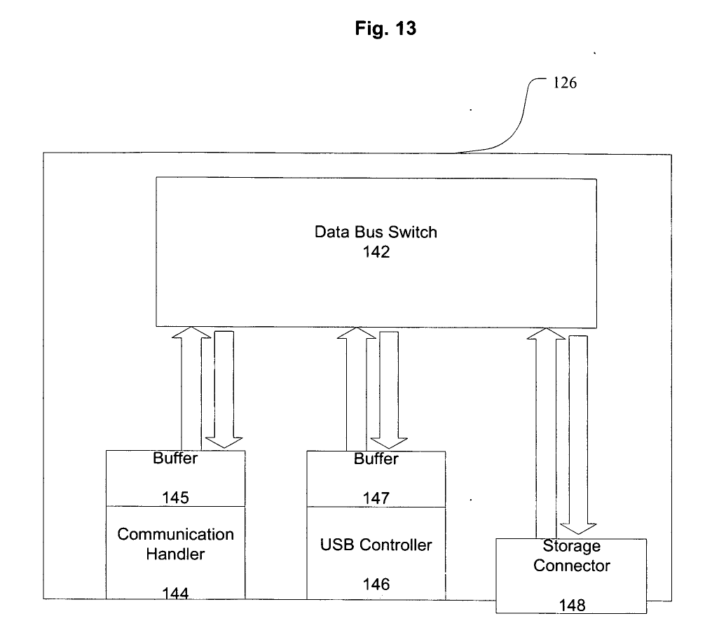

The connectivity controller 126 allows the identity processor 120 to activate a particular connectivity path with a host. The controller 126 also detects the presence of the connectivity with a host. The path activation is done as follows: The controller 126 in FIG. 7 is detailed in FIG. 13. The controller 126 has components namely a bus switch 142, a communication handler 144, a peripheral port controller 146, or a storage connector bus to the storage connector 148. The bus switch 142 determines the connectivity of the bus from the cryptograph engine 130 in FIG. 7 to a host eventually.

The communication handler 144 can be as simple as short distance wireless connection provided by a wireless USB or something as sophisticated as a complete IP stack based Ethernet communication. The peripheral port controller 146 can be anything that is high speed such as USB 2 or IEEE1394. Controller 126 in FIG. 1 completes the remote physical link to a host by a network connector 128. Communication handler 144 handles connector 128 with the aid of a buffer 145. Controller 126 handles attachment to a host by peripheral connector 132 which, in turns, is controlled by the peripheral controller 146 with buffer 147. Connector 148 can be a copy of the connector of the content storage 134 or a media adaptor such as IDE to SATA. The individual controllers 144, 146, 148 are capable of detecting if there is a host presence on the corresponding connectors.

The cryptograph engine 130 takes the cryptograph key from the buffer 124. The cryptograph engine 130 performs encryption during data input and performs decryption during data output. It selectively processes in DES or AES type of encryption key to encrypt data or to decrypt data for data flow in and out of storage 136.

The content storage 136 is identical to the storage 36 used in the preferred embodiment, FIG. 1. They behave the same. It is typical hard disks used on a personal computer, or the hard disk equivalent types of other mass storages.

### Operations—FIG. 14

The invention is primarily used as an external content storage such as a hard disk with a USB adaptor to a host. The content access aspects are identical to a typical hard disk after the user authentication. To bind a storage media, encryption is used. The content encryption is done on the flight and it is transparent to a user. Once a user has passed the blocking mechanism of the invention, the authentication process, the invention would, behave just like a regular hard disk drive. The following describes a typical scenario of how the invention is used so that the operation of the invention can be described with an appropriate context.

The user connects a new instance of the invention to the host after a new disk is installed in the embodiment. The device is connected to a USB 2 port of a host. The unit is powered on. The enrollment LED 182 is on and the user enters a pass code for enrollment purposes. The system requires the user to enter the pass code for the second time to confirm the pass code. If the pass codes do not match each other, the user can press cancel button in FIG. 12 to start the enrollment process all over again. The user eventually completes the enrollment successfully and the unit power indicator is lit. Meanwhile the storage media is recognized by the host to proceed with disk initialization which binds the disk to the rmbodiment. When the initialization is done, the disk is used as a regular disk without any particularity. From that moment on, the user can disconnect the unit from the host as a regular external USB 2 based disk peripheral. When the device is reconnected to a host, the authentication LED 180 is lit. And the user enters, via numerical keypad 112, the pass code once used for disk initialization process. The pass code is checked out ok and the device then appears to be an active USB 2 device to the host. The host is then used the disk as a regular disk without any particularity.

One day a coworker of the user wants to access the data in the device, he first just take the device and plug in the device into his computer with a USB 2 connector, the device turns on the authentication LED 180 and waits for the user input. The device appears disconnected to the host. The coworker attempts many times of entering a code via the numerical key pad 112 on the device without any success. The coworker opens the device and takes out the disk 136 inside. He then places the disk into his own USB 2 adapter box. His host now can sense the disk but only as an unformatted disk. He quits the attempts and asks the original user, the owner, of the embodiment for help. He asks the owner to authorize him to see the content on this protected disk. The owner powered on the device and entered his pass code. Within the first few seconds of passing the PC checks, the owner presses the enrollment key 176. The enrollment LED 182 is lit and the coworker of the owner is asked to enter a pass code via the numerical key pad 112. The coworker enters the code and the device proceeds to light the authentication indicator 180. He now enters the pass code he registered previously, he now can see that the disk has been successfully attached to the host and he is able to access the content on the disk.

The flow chart in FIG. 14 starts from step 600 and ends at step 670 has all the operation scenarios mentioned covered.

### Binding Operation

The binding process ensures that the physical items that can be separated from the body of the invention are used together always. With the exception that the authentication requires a user to enter a pass code, the binding between the storage and the embodiment is identical to that of the preferred embodiment.

### Enrollment Process

The enrollment indicator 182 is lit, as stated in the preferred embodiment, at three occasions namely a brand new instance of the embodiment, the owner ship transferred, to enroll a new user.

A user uses the keypad 112 to enter a new PC of choice to complete enrollment when enrollment is automatically assumed. The enrollment is assumed when there is no PC records in the storage 156. Decision 602 checks that. When there is no PC records 138, the device assumes the enrollment mode and set the LED 182 in step 606 automatically. Step 608 turns on the busy LED 184. In step 610, a user presses a 12 digit codes of his choice. The system confirms that the code length of the input is adequate in decision 612. The OK LED 188 is lit, in step 616 when PC length is acceptable otherwise an error LED186 is lit in step 614.

The enrollment process can be entered via label B 604 which is invoked by the step 654 when a user presses the enrollment button 176 after the individual has passed the authentication process from step 632 to step 648, which will be detailed in the authentication process described below.

To force a user to memorize the PC picked, the user is asked, in decision 618, to do these several times until there are 2 continuously matched and acceptable PC. When everything is checked out, the step 620 set LEDs: a power LED 190 in FIG. 11 is lit, the enrollment mode indicator 182 is turned off, the connectivity mode LED 192 is turned on, and the busy status LED 184 is tuned off. Step 622 waits for the connectivity path selection is made by the user via the numerical key pad 112. The newly created PC record is updated with the connection path specified. A label pair 624 and 630 takes the processing into authentication mode. The authentication mode is detailed next.

### Authentication Process

A busy indicator 184 in FIG. 11 flashes when a host is connected to the embodiment. It signals that the device is not quite ready for input. After a few seconds, a green authentication mode LED 180 is eventually lit and the device is ready to read the ID information. A user punches in the PC for PC reader 150 to pick up the code entered. The PC verifier 152 checks the newly read PC against the PC records 138 in PC storage 156 via PC handler 154. If a match is found in decision 638, the authentication is considered passed and the OK indicator 188 is lit. Otherwise, the user can then try again. If the PC matched is the first record, then the user is the owner of the device. This information is useful when there is a need to perform ID information management such as purge or enroll additional PCs. It is assumed that the first enrolled individual is taken as the owner or the administrator.

In the flow chart depicted in FIG. 14, the steps 630 to the steps 670 deal with the normal operation which is authentication mainly. When decision 602 determines that there is PC information, the device assumes the authentication mode automatically and in step 632 turns on the authentication LED 180. Meanwhile the busy LED 184 is set on by step 634 to wait for the invention to stabilize right after the power on. The step 636 reads the PC when a PC is entered. Decision 638 checks if the PC entered matches any PC record in the PC storage 156. If there is no matched PC record, step 640 sets on an error indicator 186 and waits for another PC entered. Step 642, when the PC entered matches a PC record 138, makes changes to the LEDs: off for error LED 186, on for OK LED 188, and off for busy LED 184. The matched PC record order is remembered in step 642. Step 644 fetches the encryption key root 139 from the PC storage 156 to generate the encryption key.

Decision 646 determines that the user is not an owner and the connection detected has matched the connection in the PC record remembered. Step 648 places the encryption key generated in the encryption buffer 124. Decision 650 then determines that the user is not the owner and proceeds to complete the connection to a host in step 666. Step 668 then erases the encryption key in the encryption buffer 124.

When decision 646 arrives at the conclusion that the right connectivity path has not been used and the user is not an owner, the step 662 is taken to signal error. The error LED 186 is lit for 3 seconds in step 664 before the PC module is turned off in step 670. This particular set of decisions and steps is actually access blocking by connectivity. When the connection path value is set to one and the payload of a particular PC record 138 is used, this access blocking can be very effective.

There is also a timer involved in decision 650 to see if, within 3 seconds, the owner would do any additional action; hence, a check in decision 652 is done to see if either the purge mode 172 is pressed or the enrollment mode 176 is pressed by a user. If the enrollment mode is pressed which is checked in decision 654, then the process would follow the flow chart label B label pair 656 to 604 to perform the enrollment steps from step 606 to step 622. Otherwise, the step 658 assumes the purge mode is selected, when one of the mode key is pressed and it is not the enrollment key. Reset key 174 is not checked here because it will stop everything and returns the embodiment to the stage before the authentication process. The purged mode operation is detailed below.

### Authorization Process

Authorization can only be performed when the user is the owner and the enrollment key 176 is pressed within a set duration, i.e. 3 seconds after the authentication is passed. The process is completed after a new PC is added to the embodiment.

When a user's PC matches 1st PC record in the storage 156, there is a 3 second timer involved in decision 650. Decision 652 checks if change of operation mode is signaled. Decision 654 checks if the enrollment key 176 is pressed. If yes, proceeds to follow the flow chart B label pair 656 to 604 and into the enrollment process.

### Purge Process

In the business world, it is quite common that the content has to be transferred from one individual to another due to promotion, job transfer, or resignation. In this circumstance, it is crucial to allow the device to be able to erase all the ID information to accept the IDs for a new owner and new users. The invention allows the erases of all PC records 138 without affecting 139 which is the encryption key root. A user, also an owner, after authentication process presses the purge button 172 to invoke the purge action.

In FIG. 14, the purge mode is invoked after step 658 to step 670. Before the purge mode is invoked, the authentication process has to be passed as described above. The step 658 changes LEDs to inform a user: the purge mode LED 178 in FIG. 10 is turned on, the status OK LED 188 is turned off, and the busy status LED 184 is turned on. The invention monitors the progress by decision 660 during the process of erasing PC records 138. Step 662 turn on the error LED186 if for some reason the PC records 138 can not be removed completely. The OK LED 188 is turned on as soon as the purging task is completed. Meanwhile it turns off purge mode indicator 178 and busy indicator 184. The encryption key in the buffer 124 is removed in the step 668.

### CONCLUSIONS, RAMIFICATIONS, AND SCOPE

Hence, a common storage media placed in the invention becomes a tempering proof content protection storage device that is secured and easy to operate.

In the description, the encryption root can be replaced by the encryption key itself, if the tempering proof is acceptable to stop at the hardware chip tempering. The encryption key root is used to prevent chip level memory dump like tempering attempts. It is also possible that the binding process can be done with means other than the encryption binding. For example, physical tempering proof would destruct the protected storage media when physical separation of the media from the invention is attempted. Accordingly, the scope of the invention should be determined not by the embodiments illustrated, but by the appended claims and their legal equivalent.

I claim:

1. A content protection storage device has a standalone security process for the content protection for individual storage media.

2. A content protection device of claim 1 wherein said standalone security process comprises of at least authentication, authorization, and encryption.

3. A content protection device of claim 1 wherein said content storage is as small as a single hard disk or an equivalent mass storage device.

4. The content protection device of claim 1 wherein said content protection is provided by access blocking on the device and binding the protected storage media to the device itself.

5. The content protection device of claim 1 wherein said standalone security process implies that the access blocking management and binding process is done completely by the device itself and does not require the connected host to be operational.

6. The content protection device of claim 1 where said standalone security process implies manageability of, at least, storage media binding, new user enrollment, authentication, and ownership transfer.

7. A standalone content protection storage device that provides protection to content without the need for a physical key of any kind.

8. A standalone content protection storage device in the claim 7 wherein said protection of content is for an off line storage that has been through encryption process in the device with an encryption key that does not statically exist in the device.

9. A standalone content protection storage device in the claim 7 wherein said protection of content is done with the access blocking on connection that can be detected by the device itself.

10. A content protection storage device in the claim 7 wherein said physical key implies the use of a token key, a smart card, a mechanical key, or information imported in any form from other than the designated user interface of the device.

11. A content protection device for individual storage media can be used for a host of any generic or operating system so long as the physical connector of said device is supported on the host.

12. The content protection device of claim 11 wherein said supported connector means that the host can physically connected though such connector and has a corresponding driver to perform content access.
